(19) United States
(12) Patent Application Publication
(10) Pub. No.: US 2002/0116234 A1
(43) Pub. Date: Aug. 22, 2002

(54) Method for providing information service and for managing information processing resources

(76) Inventor: Mikio Nagasawa, Kodaira (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 09/942,700

(22) Filed: Aug. 31, 2001

(30) Foreign Application Priority Data
Feb. 19, 2001 (JP) 2001-041126

(51) Int. Cl. G06F 17/60

(52) U.S. Cl. 705/5

(57) ABSTRACT

A method for providing information service is disclosed that enables resource procurement in a compatible manner among information processing service resource providers which are hard to uniformly manage because of the variation of quality and performance of resources provided, develops a market of freely trading adequately-performing resources based on performance simulation, and operates the management system of resource trading in such market. In the disclosed method, the parametric data of performance of resources provided by service resource providers are maintained as credit management data and the following are performed: simulating estimated service performance of resources, based on the performance request specifications presented from a service user and the credit management data, thereby allocating combinations of resources that satisfy, in the aggregate, the request specifications; issuing a resource reservation ticket of the resources to the user; and placing an order with the resource providers for the resources so that the providers will run the reserved resources on contract.

### BACKGROUND OF THE INVENTION

The present invention relates to a method of utilizing resources allocated for an information processing service. More particularly, the present invention relates to a method of issuing a reservation ticket of resources for an information processing service, based on resource run performance evaluation by simulation; a method of scheduling resource utilization for service in combination of credit management data recorded on an electronic medium, and a suitable method for resource trade brokering/booking based on a mathematical planning approach for seeking a solution satisfying user-optionally-specified performance requirements by merging a plurality of resources.

There are a number of techniques about trades of resources for information services, including methods of futures trading in the financial market, credit (risk) processing classified as UPC 705-38, methods of computer processing for market analysis, demand forecasting or surveying classified as UPC 705-10, methods of metering distributed electric energy for charging and accommodation classified as UPC 705-63, methods of electronic shopping (e.g., remote ordering) using the Internet classified as UPC 705-26, methods of load distribution by staff scheduling or task assignment classified as UPC 705-9, and application processing service systems using the Internet provided by an organization called an Application Service Provider (ASP).

These techniques, however, do not quantify the information processing service performance by converting it into value, but temporarily converts service into the value of money for trade implementation and payment.

Conventionally, there exists a remote communication network system in which service functions are assigned to service offering facilities and many programmable resources as disclosed in Japanese Translation of unexamined PCT Appln. No. 507785/1999 (WO96/42173). When a service is called for to the above system and the system allocates resources for the service, according to the above function assignments, the system determines function and resources necessary and sufficient for the service and time during which the function and resources are required to run and judges whether the resources are available. This conventional system example relates to guaranteeing service performance by prejudging service function and resource availability before service execution, that is, it relates to a function serving the purpose of preventing nonfulfillment of a contract. However, it does not provide a brokering function including negotiation for reserving the resources for a service or managing to procure the resources satisfying service performance.

The above conventional system example is simple network service implementation and judgment of whether resources are available is simple, but does not have the capability of determining whether resources in the aggregate can satisfy a plurality of types of service request specifications, for example, determining resource performance and capacity by simulation. This system does not have the brokering function and the maximum capacity of a single entity of resources in the system is statically determined. Accordingly, resources more than the maximum capacity must be procured in a free market.

JP-A-242968/1998 discloses a service management apparatus that performs management of the users' rights to utilize resources and simulates and determines the service performance of the resources to be utilized by the user. This apparatus serves the purpose of allocating limited resources for a user and a function of procuring resources to satisfy the request specifications from the user is not disclosed in this publication.

JP-A-92123/2000 discloses a method for priority control of communication flows by specifying computer user information in packets. The publication, however, does not describe a method of assigning licenses.

As disclosed in JP-A-32037/1999, there exists an apparatus that uses a prepaid access ticket to authenticate a user who can utilize programs and discounts a rate of the prepaid count to decrease, according to the number of times the user accessed programs. For this apparatus, allocating program processing resources is independent of guaranteeing resource utilization to the user. If the resources are not sufficient, it is conceivable that a prepaid card for which resource capacity is not enough is issued. This apparatus lacks a resource reservation ticket function.

As disclosed in JP-A-63364/1998, there exists a system in which a plurality of users will get the right to utilize contents by payment for purchases and the system has means for judging whether the user can utilize certain contents and permitting the user to utilize contents, based on the conditions set, according to how much the user paid for purchases. This conventional system example is assumed a single large central system and its purpose is cutting the cost of building the central system.

An apparatus that controls communications resources also exists as disclosed in JP-A-232201/1999. This apparatus has means for allocating resources to a plurality of communication processing servers via an agent of managing communications resources and allows its user to select one of the servers so that one link will be selected between one of the many communication processing servers distributed and deployed in a wide area network and the user terminal, thereby supporting network architecture. However, this apparatus does not guarantee the performance of the resources.

As disclosed in JP-A-20386/2000, a push-type information distribution system also exists. This system requests a distribution agent computer to undertake the data distribution loads of computers serving as data providers, according to a predetermined judgement procedure. This conventional system example is not provided with a reservation function.

As disclosed in JP-A-250990/1994, there exists a computer access control apparatus. This apparatus, not relating to load distribution, has means for taking quick countermeasures against unauthorized access to computer resources by which a computer resource subjected to unauthorized access is shifted with its name remaining unchanged.

As a device that is capable of processing reservation tickets as a medium, there exists an electronic money holding device which makes it possible to automatically perform a payment having an amount payable and a due date both known from a contract beforehand, as disclosed in USP 6058382. Based on the conversion of all transactions to the measure of an amount of money payable, this device is not adaptive to price fluctuation and current price, and does not take parameters of multiple variables that are different for different applications into consideration.

The purpose of the above-mentioned conventional techniques is to share the processing capacity of one central system that can be provided by an existing information processing system administrator with information processing service users. However, these techniques lack the consideration of an aspect of allocating resources for satisfying specific requirements of the information service users and consequently a problem has arisen that the service users sometimes cannot get services that satisfy their requirements.

### SUMMARY OF THE INVENTION

An object of the present invention is to allocate information processing service resources with enhanced efficiency, security, and reliability of information processing services under circumstances where a plurality of users of information processing service resources and a plurality of information processing service resource providers coexist.

Another object of the present invention is to implement risk distribution and optimum operation in procuring resources for information processing service in an open market of trading adequately-performing resources, not intended for controlling the operation of only a single information processing system, in order to reduce unprofitable investment in multiple infrastructures in the background that the resources for information processing services are becoming regarded as one of the lifelines.

Yet another object of the present invention is to enable resource procurement in a compatible manner among information processing service resource providers which are hard to uniformly manage because of the variation of quality and performance of resources provided, develop a market of freely trading adequately-performing resources based on performance simulation, and create a bushiness model for operating the management system of resource trading on such market.

In order to achieve the foregoing objects and in accordance with the present invention, a booking/brokering system of resources for information processing services is architectured. This system comprises a means for controlling brokering and booking resources for offering a service (the means will be referred to as a brokering means hereinafter) intervening between resources for information processing services to be offered by a plurality of providers of the resources for information processing services and administrators of operating information service systems including computer platforms (both the providers and administrators will be referred to as service resource providers hereinafter) and users of the resources. The brokering means holding credit data including resource performance data for the resource providers comprises the steps of receiving performance request specifications of resources for a user-desired service from the user, simulating estimated service performance of resources, based on the request specifications and the credit data, thereby allocating one or more combinations of serviceable resources that satisfy, in the aggregate, the request specifications, issuing a resource reservation ticket to the user, the ticket including data that entitles the user to utilize the one or more combinations of resources, and placing an order with the resource providers for the one or more combinations of resources, thereby booking the resources for the user.

The above booking/brokering system issues a resource reservation ticket regarding the resource providers' resources booked for the resource user. To the resource reservation ticket, indicators are assigned as pointers to the providers of the resources for the information processing service on contract. The booking/brokering system maintains the database of the credit management data. Based on the indicators assigned to the resource reservation ticket, the system can offer the user advantage such as discounts and guarantee on a service, according to the resource user database and the resource providers' credit management data.

If the above resources to be utilized are computers allocated on a time basis, some obscurity of their response time estimation for a service is inevitable. Notwithstanding, by assigning guaranteed performance parameters such as service type, capacity, date/time of execution, average response time, maximum response time, etc. to a plurality of systems as the particulars of the right to utilize the reserved resources, the present invention makes it possible to estimate the performance of a virtual system with larger capacity by system performance simulation including the dependency on time. Thereby, a better solution will be found for load distribution or risk hedge schemes with higher possibility as compared with seeking a solution for small systems.

Service quantification is also made possible by obtaining the estimated values of the performance parameters of the service itself rather than the computer platforms. Accordingly, change to the organization of computers on runtime to optimize ongoing process execution can be made without changing the user's performance request specifications. In this way, dynamic optimization control can be performed directly and quickly.

For load distribution purposes, the estimated values of the service performance parameters obtained by performance simulation to acquire performance data of respective service offering systems should be recorded for each simulation. Quantitative evaluation of both estimated respective system performance and estimated performance for a plurality of service offering systems, such as, for example, parallel processing performance can be made. As compared with the conventional load distribution scheme whereby computers are simply controlled to run at a uniform operating ratio, the present invention enables service execution scheduling that is more efficient

As one advantage provided by the present invention, by virtue of the brokering of dynamic reservation and allocation of adequately-performing resources to be used for an information processing service, the allocation of resources performing well enough to satisfy the request specifications from a user of resources for information processing services can be guaranteed to the user.

As another advantage provided by the present invention, by virtue of the brokering of reservation of adequately-performing resources to be used in conjunction with managing the credit managing data, the reserved resources will run with more secure and reliable run-time performance and the reliability of trading is enhanced. Whether the service performance requested by the user is based on the performance data reported by the service resource providers or it is a very new service, indicators (for example, credit ranks) of respective providers in the evaluation from the past service offering achievements are used to complement the estimated performance values so that the uncertainty of these values will be quantified. From the dispersed values of parameters of estimated performance of the service resource providers, adjusted with their credit indicators, by selecting a degree of freedom of combinations, or in other words, a portforio, the resources can be organized in combinations with security and higher estimated performance values.

With the intervention of the function provided by the present invention, that is, brokering and trading the adequately-performing resources for information processing services, a whole system covering a plurality of providers of such resources interconnected by a network is architectured as one market system in which these resources are traded. Thereby, a method for estimating the resources for offering t information processing services which are and will be stable and efficient in future can be provided.

Other and further objects, features and advantages of the invention will appear more fully from the following description.

### BRIEF DESCRIPTION OF THE DRAWINGS

A preferred form of the present invention illustrated in the accompanying drawings in which:

FIG. 1 is a block diagram representing an entire system configuration for a preferred embodiment of the present invention;

FIG. 2 is a schematic diagram for explaining processing flows of operations according to the preferred embodiment of the present invention;

FIG. 3 is a flowchart illustrating resource reservation processing to be carried out by a brokering system in the preferred embodiment of the present invention;

FIG. 4 is a flowchart illustrating credit data management processing when resources are used in the preferred embodiment of the present invention;

FIG. 5 is a block diagram representing a hierarchical booking/brokering system configuration in the preferred embodiment of the present invention;

FIG. 6 is a block diagram representing a system configuration when resources are used in the preferred embodiment of the present invention;

FIG. 7A, 7B, and 7C show performance information and credit management data output examples in the preferred embodiment of the present invention; and

FIG. 8 shows examples of resource performance simulation presentations displayed on screen in the preferred embodiment of the present invention.

### DETAILED DESCRIPTION OF THE PREFERRED EMBODIMENTS

In the above-described constitution of the present invention, other features of the present invention in other aspects are recited below.

The brokering means executes simulation of the performance of resources, based on the user's request specifications, allocates the adequately-performing resources of one or more resource providers, according to the result of the simulation, determines what quantity of resources are necessary and sufficient for fulfilling the request specifications and time during which function and resources are required to run, and issues the resource reservation ticket, according to the allocation, wherein the brokering means will issue the respective resource reservation tickets to a plurality of service users (customers). Moreover, after successfully reserving the resources, the brokering means sends the service performance request specifications, based on which the resources have been reserved, to the providers of the allocated resources, and when the resource providers determine their service resources required to execute the service in future, the brokering means compares available function and resources and required function and resources for a specific period and manages the thus obtained data to decide whether the service providers can provide additional service performance resources.

In the constitution of the present invention, data to be written to the resource reservation ticket to be traded includes a requested service type and service performance data in which maximum time and average time estimated to be taken to execute the information processing service are specified and the brokering means performs at least either estimating whether the resources can execute the information processing service described in the performance request specifications or estimating how well the resources satisfy the performance request specifications.

The constitution of the present invention further includes a means for re-estimating the performance of resources for an additional order, the means to re-calculate resource performance specification parameters necessary and sufficient for executing the information processing service specified in the user's performance request specifications and present the data of the calculated performance specification parameters to the resource providers if the brokering means estimates that the resources cannot execute the information processing service specified in the performance request specifications within the maximum time.

In a further aspect of the invention, the reliability of the service providers is evaluated by comparing the guaranteed service performance of the reserved resources and the service performance during or after the actual run of the resources and the evaluation output data is recorded as part of the credit data.

In a still further aspect of the invention, if one or more allocated resources on computer platforms become unable to operate when executing the service, switching from the resources of relatively low reliability service performance to other resources of relatively high reliability service performance is performed by dynamically gaining access to the credit data, thereby providing run-time endorsement of the resource reservation ticket.

In yet another aspect of the invention, the brokering means determines whether the resources can provide the service from the performance data of the resource providers' computer platforms required to execute the service, while taking the providers' credit evaluation into consideration by referring to the credit management data.

In a still further aspect of the invention, the brokering means edits the performance request specifications data for an information processing service electronically sent from the user of the information processing service into resource reservation data for assigning the resource run tasks to the resource providers, according to the information processing service type, electronically sends the resource reservation data to the appropriate resource providers, issues the resource reservation ticket created with the input of the resource reservation data, and stores the resource reservation data into a storage medium for management.

In yet another aspect of the invention, the above-mentioned brokering system may be comprised of a plurality of brokering systems in multilevel hierarchical structure, each brokering system including a resource management table, means for registration, and a storage medium, arranged such that lower-level brokering systems gain access to an upper-level brokering system as a user of the brokering system. The resource management table of the upper-level brokering system contains partial data, a copy of the relevant part of Service Level Management data, resource reservation data, credit management data for service resource providers which are maintained in the lower-level brokering systems. The top-level brokering system at least includes the above-described brokering means and group-bounded service request specifications data, and users' service request specifications input to the lower-level brokering systems are collected as the group-bounded service request specifications data on the top-level brokering system.

In a still further aspect of the invention, an apparatus for authenticating an authorized service user is provided. The apparatus comprises a means for authorized service user authentication which authenticates that the user is authorized to use service by verifying the validity of the user's resource reservation ticket issued to guarantee the right of the service user and the performance of the resources to execute the service, a first storage means to store the resource reservation ticket data, a second storage means to store resource allocation information, a means for communication between the first storage means and second storage means, and a means for verifying certificate data which executes predetermined arithmetic processing based on algorithm for encryption/decryption and other security purposes for the reservation data and resource allocation data and verifies the validity of the resource reservation.

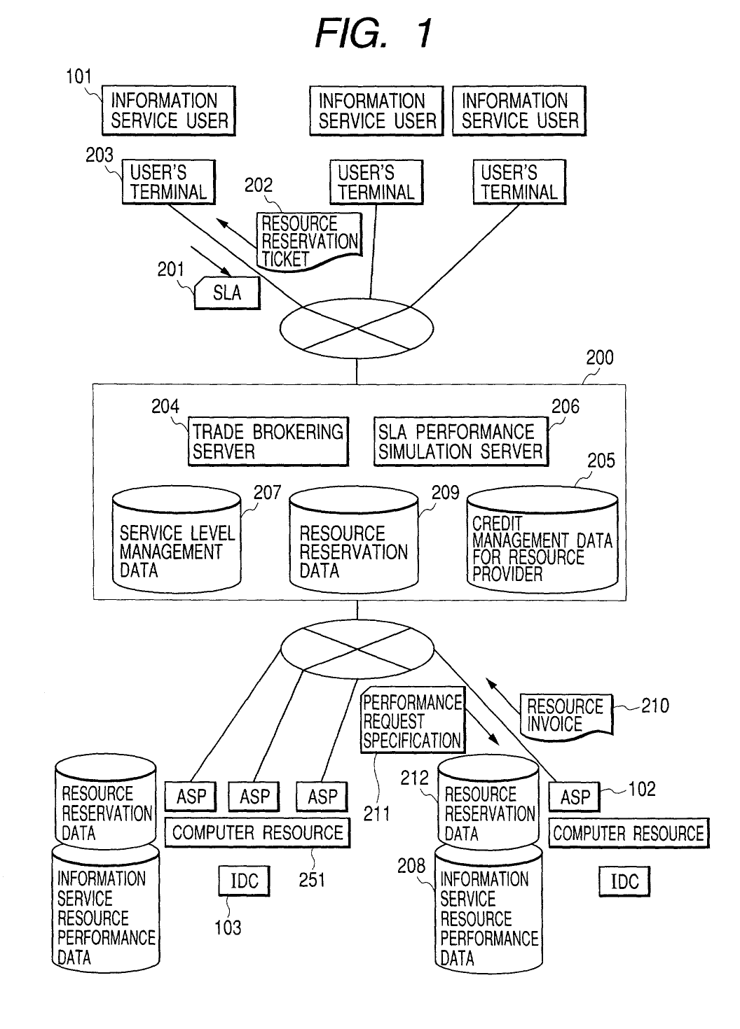

A preferred embodiment of the method for providing information service of the present invention will now be described with reference to FIG. 1. FIG. 1 provides an overview of a system configuration for carrying out the present preferred embodiment. In FIG. 1, reference numeral 101 denotes a user of resources that operate to provide an information processing service (the user may be simply referred to as a customer hereinafter). Reference numeral 102 denotes a provider of the resources for information processing services, such as an Application Service Provider (ASP). Reference numeral 103 denotes an administrator of operating the resources for information processing, such as an Internet Data Center (IDC). Reference numeral 200 denotes a trade brokering system for resource booking: 201 denotes service performance request (SLA: Service Level Agreement) specifications; and 202 denotes a resource reservation ticket. Reference numeral 203 denotes a terminal computer operated by an individual user of the resources for information processing services. Reference numeral 204 denotes a trade brokering server (computer); 205 denotes credit management data for the providers (ASPs or IDCs) of resources for information processing services; and 206 denotes a resource performance (SLA performance) simulation server. Reference number 207 denotes Service Level Management data (according to customer's performance request specifications); 208 denotes information service resource performance data; and 209 denotes resource reservation data. Reference numeral 210 denotes a resource invoice; 211 denotes performance request specifications separated for a resource provider; and 212 denotes resource reservation management data for resource providers. Reference numeral 251 denotes equipment (computers) to be provided as the resources for information processing services.

The present system is built in hierarchical structure comprising the terminals 203 respectively operated by the users (customers) 101 of the resources for information processing services, the brokering system 200, and the system built on the side of the providers of the resources (computer resources) 251 for information processing services. The providers 102 such as ASPs of information service resources provide software resources such as application software running on the computer resources 251.

The brokering system 200 allocates information processing resources (in the system to offer information services) 251 for being utilized by a customer (information service user) 101, based on the resource reservation data 298. The resources that match the resource reservation ticket 202 of the user are allocated.

In the above brokering system 200 for resource booking, the SLA performance simulation server 206 estimates and evaluates the performance of the resources to be provided by the resource providers (ASPs and IDCs) by performance simulation. The trade brokering server 204 weights the result of the performance estimation and evaluation with the relevant credit management data 205 and executes calculations. Then, the trade brokering server 204 executes calculations for resource trading and booking and presents the conditions for booking.

To an aggregate of service resource providers (such as ASPs 102) that sufficiently satisfy the performance requirements, the above brokering server 204 sends data that specifies a procedure of reserving resources for performing a service including priority control information such as service scheduling. The data is stored as resource reservation data 212 into its database. The resource reservation process for the service is competed by receiving consent data (resource invoice) 210 from the service resource providers. Then, the next step begins for monitoring the process of information service execution based on the resource reservation and order placement.

When we conceive that the above brokering system is operated by a business organization, its operator can be classified as one of the following:

(1) A business organization operates both the brokering system and the service offering system.

(2) An independent business organization operates the brokering system only.

(3) A provider (102) of the resources for information processing services operates the brokering system.

(4) An administrator (103) of operating the resources for information processing operates the brokering system.

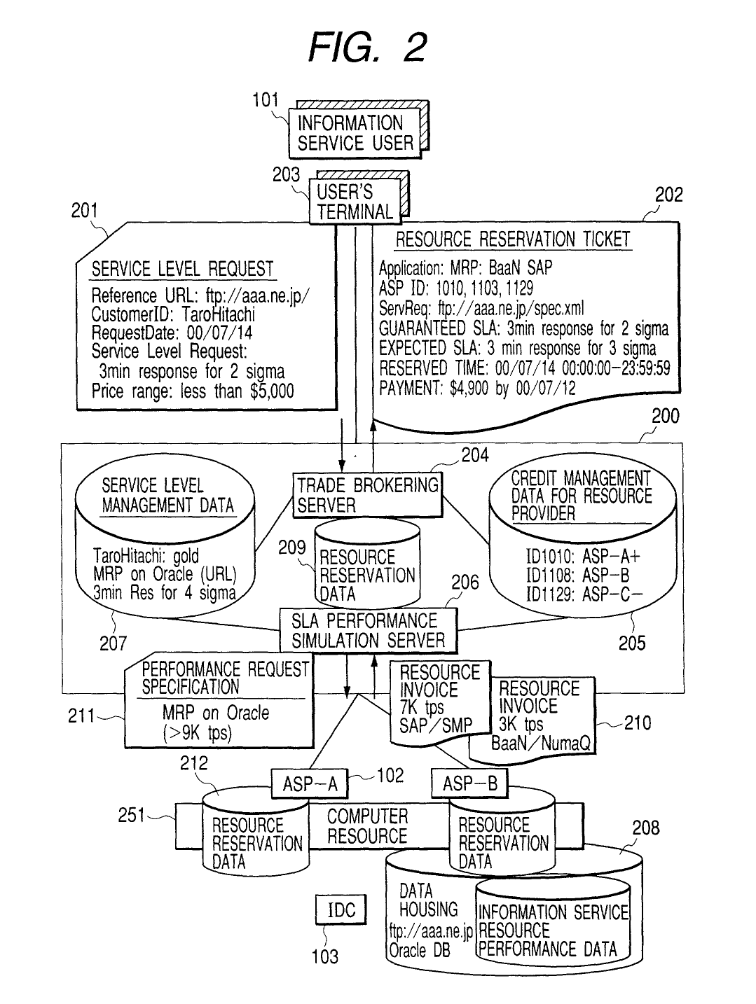

With reference to FIG. 2, functionally specific operations and their processing flows in the resource reservation and brokering process will be explained below.

(1) Assessing performance in advance (credit management and examination)

The brokering system 200 accepts request for a service to be realized by optimum resource utilization from a customer 101. Based on the SLA (service level request details such as date/time of utilization, desired service level, desired price, etc.) and the credit data 205, the SLA performance simulation server executes quantitative evaluation of the performance and capacity of resources according to the service type to decide whether there are the resources with sufficient performance required for the service to be successfully traded.

Hereon, as the conditions for procuring the resources with sufficient performance, a plurality of service resource providers 102 and a plurality of computer resources 251 can physically be distributed in a wide geographical range. The computer resources 251 are not necessarily placed in a common site. The means for accessing the data required for implementing the service and the means for data conversion are assumed prepared in standard compatibility forms used for ordinary communication on the Internet, for example, an XML format and a URL addressing scheme. Furthermore, data compression means and encryption means specific to a service may be used additionally.

(2) Resource reservation trading and brokering

The brokering server 204 circulates and trades the resources with the performance parameters which have been quantitatively guaranteed by the credit data 205. Specifically, the trade brokering server 204 refers to the database of the performance data 208 for the resource providers and makes an anticipatory decision of what combination of the computer resources 251 managed by any administrator 103 of operating the resources for information processing services and a service any provider 102 of the resources for information processing services can satisfy the service performance request specifications (SLA) 201.

The brokering server 204 registers the performance request specifications 211 separated for the resource providers whose resources are expected to sufficiently fulfill the requirements of the performance request specifications according to a specific service type when they are merged and individual provider's consent data (resource invoice) for service offering on contract.

(3) Issuing a service resource reservation ticket after trading (resource booking) is completed

After trading (resource booking) is completed, the brokering server 204 issues a resource reservation ticket 202 for the requested information processing service to the user (customer) 101 and stores the resource reservation data 209 for the service on contract into its database for management. The resource reservation ticket 202 is distributed in an electronic medium form applicable to distributed computer systems and contains resource reservation records such as, for example, application software in use, ASP's ID, guaranteed SLA, reserved time, payment, etc.

(4) Routing service execution transactions

The providers 102 of the resources for information processing services create and maintain a database to store the mapping of the logical names of resource, service, and function which are addressable by specifying a physical location and provides the service requested by the customer 101 who has the resource reservation ticket 202. If a plurality of administrators 103 of operating the resources for information processing can provide the same computer resources 251 by a plurality of different methods, the operation management function attached to the computer resources 251 determines and selects distributed processing and its scheduling method to satisfy the collateral specification conditions such as load balance and security as required, based on the logical resource reservation data 212.

(5) Reexamining the credit by evaluating the actual satisfaction of user's performance request specifications.

According to the present invention, a function of supervision and control of actual service performance, based on the information thereof, can be provided as a function during the service execution time included in the exercise of the resource reservation ticket 202. For example, during the service execution time, if the allocated resources become unable to satisfy the performance specifications (SLA) based on the resource reservation ticket, the resource operation management system (not shown) within the computer resources 251 takes corrective action; i.e., it transfers the control to the brokering system for reallocating computer resources or adds the performance fault detail to the credit management data 205 as the reliability-related information for the providers 102 of the resources for information processing services.

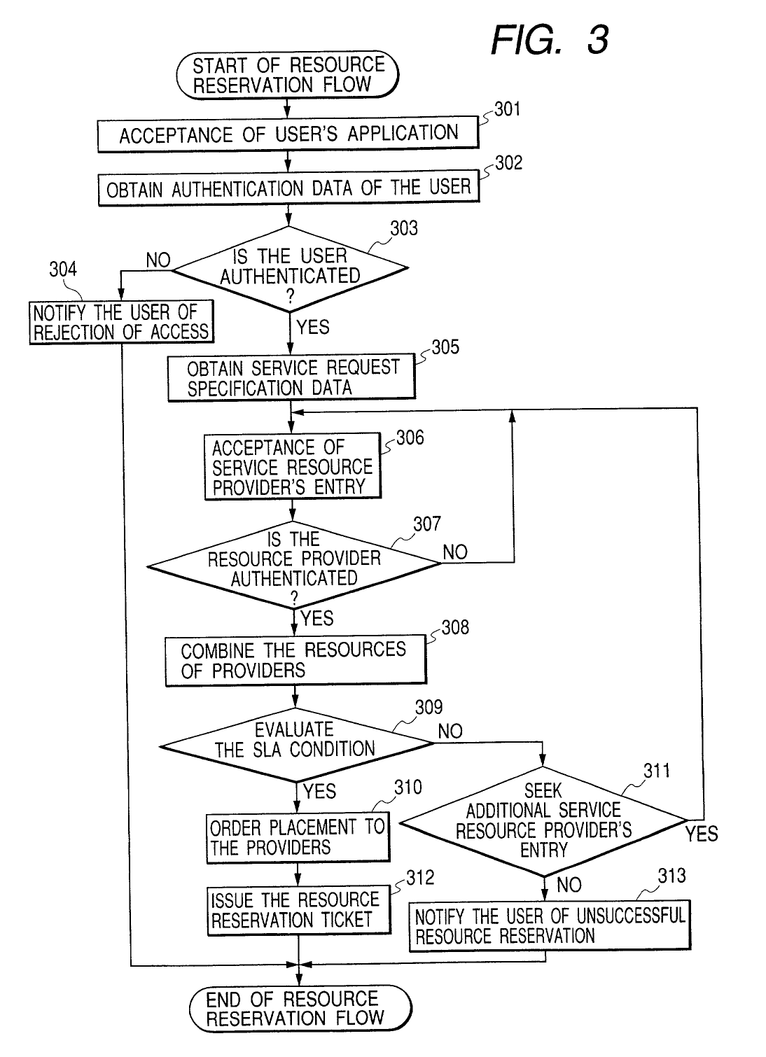

FIG. 3 illustrates an exemplary procedure for issuing a resource reservation ticket 202 including service resource provider authentication and anticipatory decision of how well the resource provider will satisfy the performance request specifications; the procedure is carried out by the booking and brokering system shown in FIG. 2.

A service resource provider 102 always open the window for accepting user's application for a service, accepts a service request from a user 101 (301), and refers to user authentication data or enters new user information if request is issued from a user 101 (302).

Judgment is made whether the user is authenticated by the entered user attribute data and/or the credit data on the past service use record (303). After the process of verifying that the user is authorized to use service, the processing terminates, rejecting the access (304) or goes to the next step (305) where the service performance request specifications (SLA) 201 are obtained. Then, in order to reserve service resources that satisfy, in the aggregate, the SLA specifications 201, the procedure of accepting service resource provider's entry (306) begins.

The brokering server 204 for booking the service resources reads service resource providers information with their credit rank data from the database of the credit management data 205 for service resource providers. By comparing the entry supplied from a resource provider and its registration, the brokering server judges whether an available provider is authentic (307). After this process, the brokering server authenticates one or a plurality of service resource providers, combines the resources (308) of the providers, and transfers the service performance request specifications and the service resource providers information to the SLA performance simulation server 206.

The SLA performance simulation server 206 estimates the resource performance of each service resource provider and its reliability, based on the transferred information and judges whether the provider satisfy the service performance request specifications (309). The result of this judgment is returned to the brokering server 204. If the resources with satisfactory performance are expected to be procured, the brokering server starts the procedure of order placement to the providers (310) and issues the ticket 202 for reserving the resources that perform well for the service on contract (312). If the performance judgment is that the expected performance of the resources is not enough to satisfy the requirement, additional service resource provider's entry is sought (311), that is, repetition of the step 306 and subsequent occurs. If additional providers are available, the step 306 and subsequent steps are executed again. Otherwise, the brokering server notifies the user of unsuccessful trading (resource reservation) for the requested service (313).

Through the simulation in the step 309, according to the information supplied for performance simulation, by calculating the required capacity and scheduled runtime of the resources to perform, satisfying the service request specifications managed as Service Level Management data 207, the resource reservation data 209 in the aggregate is generated.

In the step 312, the brokering server 204 issues and sends the resource reservation ticket 202 to the service user 101 to authorize the user to utilize the resources for the service, based on the above booking of the resources according to the simulated performance. At the same time, the server 204 sends the user the resource reservation data per service resource provider 102 whose resources are discretely reserved and ordered.

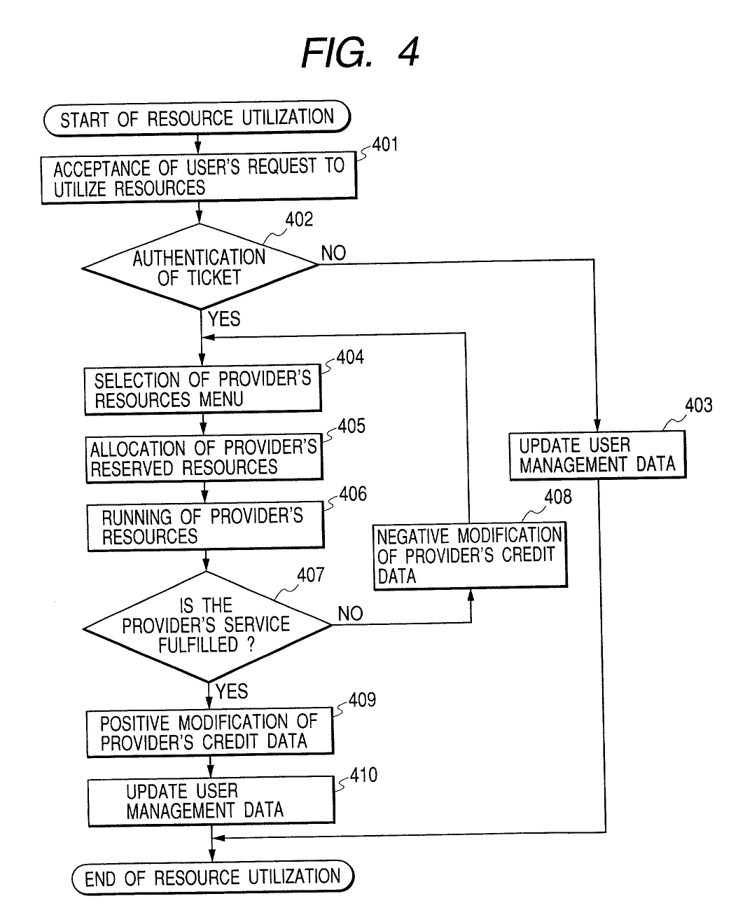

FIG. 4 illustrates a procedure of obtaining credit management data and updating the user's resource reservation data during the service execution by the exercise of the resource reservation ticket.

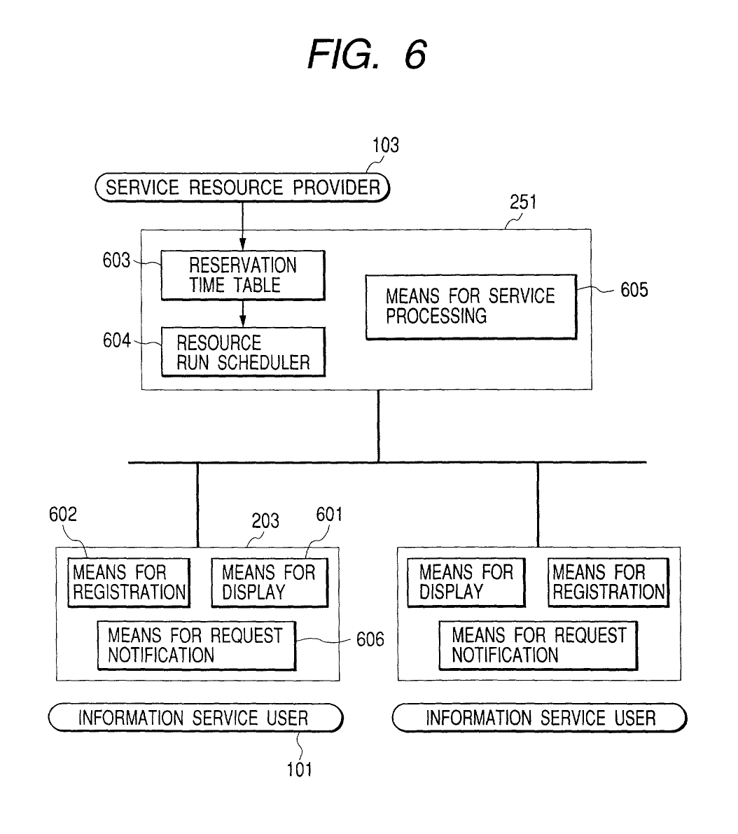

Now, refer to FIG. 6. A terminal (computer) 201 on the service user (customer) 101 side comprises the following functional entities: a means for display 601 to monitor the process of resource booking; a means for registration 602 to gain access authorization from the information service resource provider so that access permission will be granted to the user side resources or for other purposes; and a means for request notification 606 to issue an interrupt during resource booking or for other purposes. One of the computers 251 on the resource provider side (IDC 103 in this example), on which the resources allocated for an information processing service run, comprises a reservation time table 603 to contain the management data for the provider's resources (on the computer) reserved by booking of the brokering system and functional entities: a resource run scheduler 604 that schedules the provider's resources (on the computer) to run for processing of service and a means for service processing 605 to fulfill the service of user request. For the operation which will be explained below, the intervention of the brokering system is not required, and thus the brokering system is not shown in FIG. 6.

Refer to FIG. 4. Initially, a customer 101 sends the contents of the customer's resource reservation ticket through the means for registration 602 of the customer's terminal 203 to the service resource provider side. The resource management system on the service resource provider (ASP 102 or IDC 103) side accepts the user's request to utilize the resources (401) and judges whether the resource reservation ticket 202 is authentic (402).

If the judgment (402) is that the ticket is trustworthy for use, a procedure in which the service user 101 selects resources to be utilized from the provider's (ASP) resources menu (404) starts. The provider (ASP) allocates the provider's reserved resources (405) guaranteed to perform the service, sends the user's terminal sufficient information required to utilize the selected system, and permits the user to utilize the resources. On the other hand, if the request to utilize the resources is accepted, but the ticket is not authenticated by the judgment (402) as the ticket is invalid or untrustworthy, the unsuccessful ticket use is recorded as the user management data which is maintained by the provider (403).

In the means for service processing (computer resources) 251 of each resource provider/administrator 103, the information on the terms of the contract made by resource reservation is stored as the resource reservation data 212. The service resource provider allocates the resources (405) for the quantity of the resources determined to be utilized by the procedure 404 and executes actual service by running the reserved resources on schedule (406). Then, whether the provider's service is fulfilled is judged (407) by comparing the guaranteed service performance of the resources at the completion of resource reservation and the service performance during the actual run of the resources. Based on this judgment, the credit score of the resource performance of the service resource provider is updated. If the provided service does not completely meet the guaranteed performance of the reserved resources, the resource provider's credit management data is modulated negatively (408). At the same time, the step 404 and subsequent steps are repeated in order to provide a supplementary service to complement the guaranteed service performance.

If the above fulfillment judgment is that the service processing is complete, according to the guaranteed performance of the reserved resources, the resource provider's fulfillment evaluation, its credit management data is modified positively (409). The user management data is updated (410) or a record is added thereto to put an event that the service has been completely executed by the reserved resources on record. Then, the resource utilization transaction terminates.

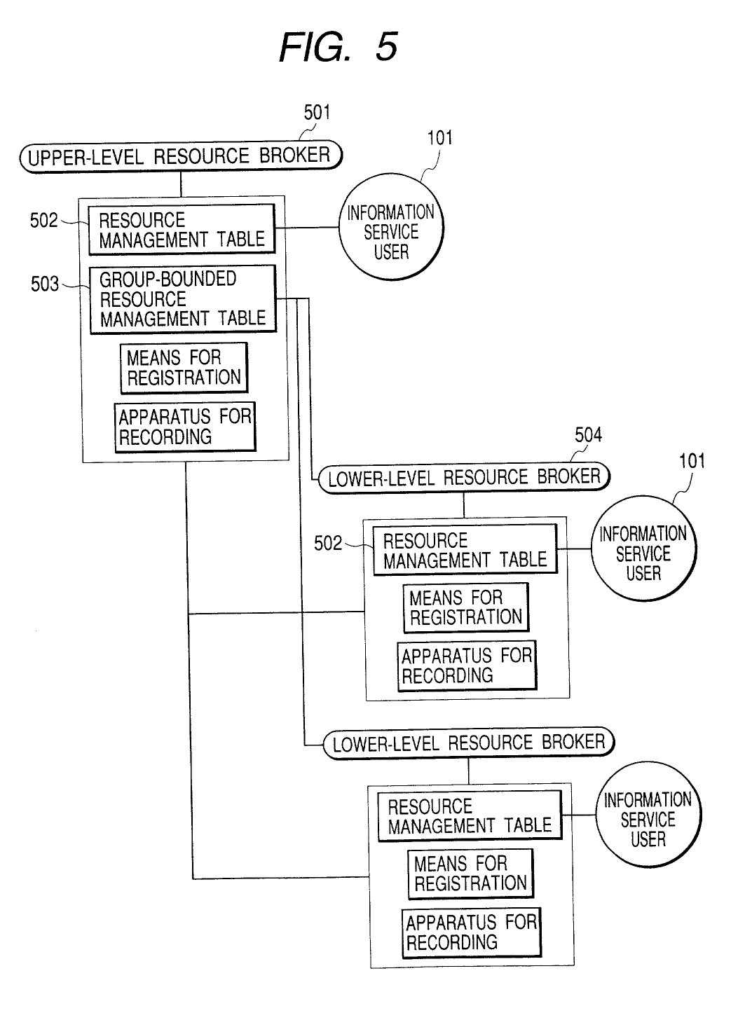

The brokering system may be built in multilevel hierarchical structure. With reference to FIG. 5, a hierarchical brokering system configuration example will be explained below. The brokering system can be structured such that lower-level resource brokers 504 gain access to an upper-level resource broker 501 as users of the brokering system. A resource management table 502 contains partial data, a copy of the relevant part of the Service Level Management data 207, resource reservation data 209, credit management data 205 for service resource providers which are maintained in the top-level brokering system 200 (FIG. 1)

The lower-level brokering systems have the means for registration and the apparatus for recording as does the top-level brokering system 200, but do not necessarily have the brokering server and the SLA performance simulation server. Service request specifications from the customers input to the lower-level brokering systems are collected as group-bounded service request specifications data which is registered in a group-bounded resource management table 503 on the upper-level brokering system. This table is retained independent of the resource management table 502 to contain data for individual users who gain direct access to the upper-level brokering system. In consequence, preprocessing of bringing same type service requests together is performed on the lower-level brokering systems. The amount of calculation of performance simulation and resource allocation to reserve the resources with satisfactory performance using large-scale service offering systems can be reduced. Even for the lower-level brokering systems, the system can be designed to achieve high-speed resource reservation processing and handle large-scale resources.

The means that are added to the resource management system for data processing required for service credit management will be explained below with reference to FIG. 6. The compute resources 251 are operated in such a manner that the resource run scheduler 604 runs the means for service processing 605 such as application programs, according to the reservation time table 603 included in the resource reservation data 212.

Individual users 101 have the means for communication with the computer resources 251, the means for request notification 606 to exercise the right of resource utilization guaranteed by the resource reservation ticket 202, the means for registration 602 of a pointer that enables access to input/output data required service execution, and the means for display 601 which displays the state of offered service performance before, during, and after service execution and the result of service execution.

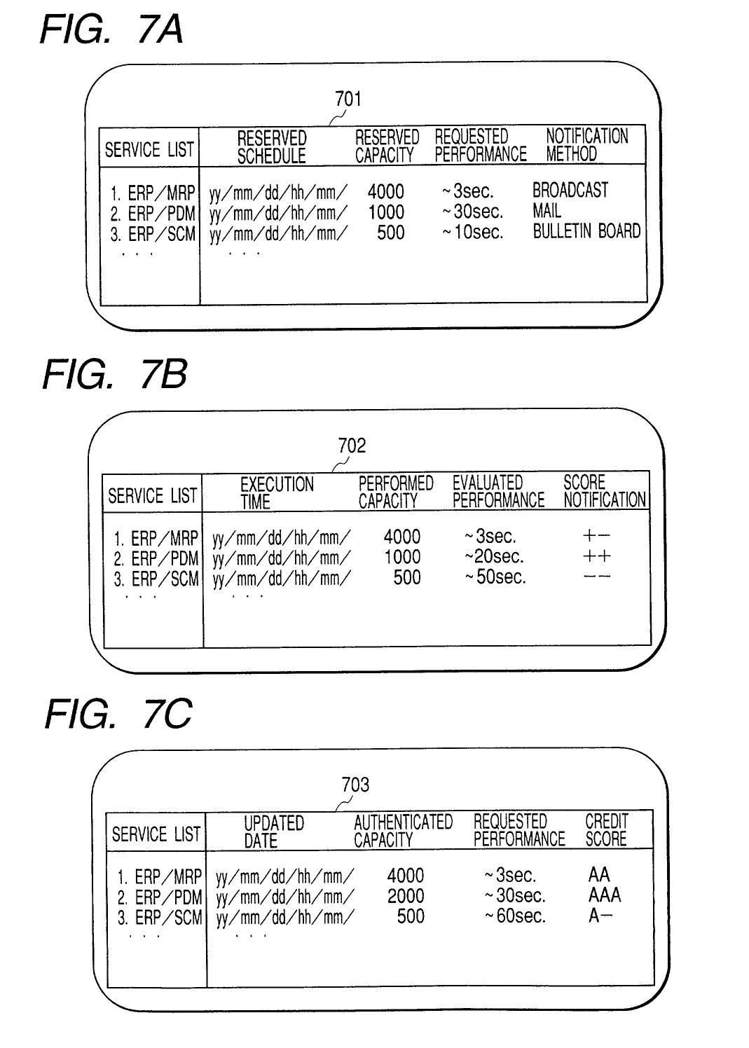

FIGS. 7A,7B and 7C show exemplary data structures of the above performance information. Tables about discrete resources 251 offered are stored as the performance data 208. The performance data for individual service resource providers 102 is stored as the credit management data 205 in the brokering system 200.

FIG. 7A represents a display example of resource reservation data 701. This data is managed to be consistent with the resource reservation data 209 maintained in the brokering system 200 and the resource reservation data 212 maintained in the resource offering system. A service offering schedule with periods during which the run of the reserved resources will satisfy the request service performance on contract, result notification methods, and other detail are specified in the table.

FIG. 7B represents a display example of performance evaluation data 702 after service execution. This data will be added to the resource performance data 208 after service execution.

FIG. 7C represents a display example of credit evaluation and score data 703 for each service offered by service resource providers on contract. The result of actual service execution is reported with performance data such as response time per service, based on which actual performance evaluation is made. Match or mismatch between such performance and the estimated performance based on the past performance data is evaluated in credit scores which are reflected in the credit data 205 maintained by brokering system. This table holds the credit score and reliability per service type.

Furthermore, according to the invention, it is possible to record the detail on analysis of uncertain factors that are supposed to cause a mismatch between estimated (simulated) performance and actual performance, such as the actual state of computer resources, the correctness of a safety factor and a failure rate used by the service resource provider in simulating the resources running, etc. for future reference use. It is also possible to store these diverse factors as service resource provider attribute data so that the data will be referred to in designing the capacity of computer resources and for improving the operation thereof when building a computer system.

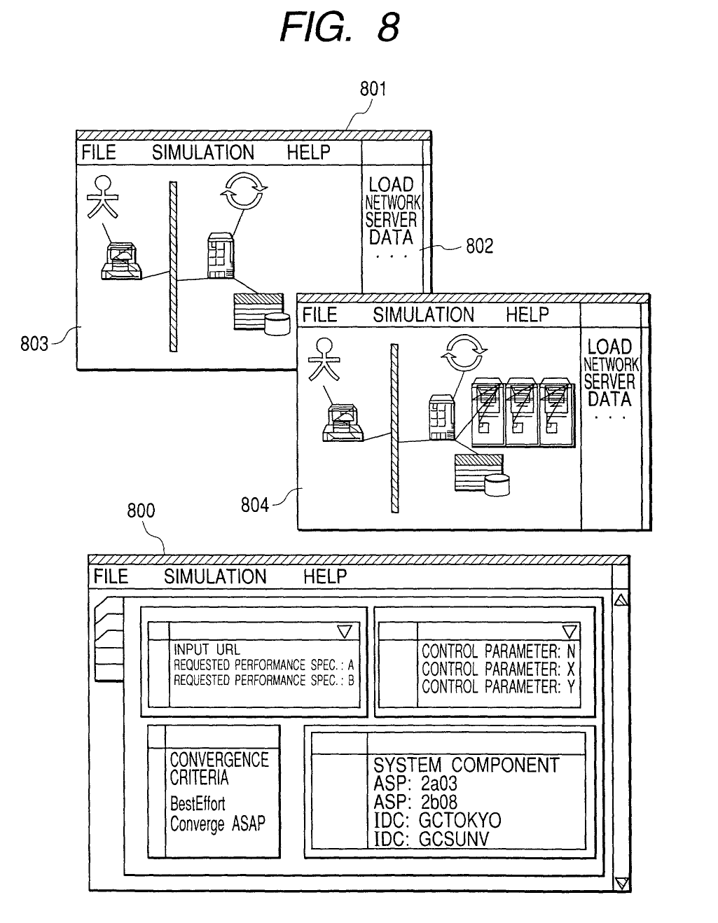

FIG. 8 shows examples of resource performance simulation presentation screens displayed on the SLA performance simulation server 206 machine that exists in the brokering system 200. On a performance simulation control screen 800, a plurality of configurations with resources are developed and shown as configuration examples and simulation and verification are performed for these examples to seek a combination of resources that can satisfy the performance request specifications. A plurality or multiplicity of system variables or elements exist that are controllable to satisfy the service performance quality as specified in the performance request specifications 211 data. Thus, the SLA performance simulation server 206 automatically and repetitively generates resources in various configurations from the minimum resources to be utilized shown on a screen example 803 to performance simulation of augmented resources shown in a screen example 804. The screen is provided with an input interface 802 allowing the operator to interactively input specification change permitted per element. The screen also has a pointer to required information and an interface 801 for simulation operation control.

The result of simulation, judgment result that the request specifications are satisfied by one or more service resource providers and combinations of computer resources will be displayed on the screen 800 and saved and stored as resource reservation data 209

According to the present invention, such a resource trading system in the market of information processing resources will be provided that places an order with resource providers for reserving the resources for a service that a user can request any time and the user can utilize the reserved resources any time. This system will reduce the possibility of service processing trouble and decrease the investment cost.

The invention also enables global load distribution in the market of trading the resources for information processing services, comparable to other markets of trading services in the electric power, communications, and other economic sectors. Moreover, its resource reservation feature lends itself to planning the expansion of facilities based on the predication of future demand trends.

The present invention provides a means for simulating the run of the resources for information processing services which will be traded and procured from a plurality of resource providers and a system for supervising and recording the flow of data and information thereof. Based on the thus stored data, credit management for the providers of the resources for information processing services can be implemented, which enables risk distribution and optimizing resource allocation.

Moreover, the present invention will be effective for enhancing the reliability of the resource trading market as a whole by enhancing the precision of subsequent simulation for estimating the performance of resources, and motivating the providers to complete one another in enhancing the provider's credit, or reliability. The credit management data is not only stored in fixed file systems or databases within the brokering system, wherein the access thereto and its use from outside the system is restricted, but also stored, after encoded by necessary encryption, into a data storage medium which can be transported or carried and managed as discrete data, so that credit data can be copied and used as part of electronically cataloged data. An electronic catalog can be created in combination with the electronic commerce service infrastructure, including both performance data and credit management data. Performance and credit data of the resource providers will be distributed so effectively that other brokering systems can evaluate the resources on a current credit rank by using this data.

The application of the present invention is not limited to the computer resources for information processing services. According to the invention, personal expertise and skill such as, for example, association and search ability and mental calculation ability will be evaluated on a common measure of resources for information processing services and easily integrated into a knowledge management system that provides such personal skill data in terms of credit management data or in an electronic catalog. In this respect, the resource reservation ticket that entitles its possessor to utilize the guaranteed performance of resources is regarded as having the effectiveness equivalent to a medium having a quantitative value substituting for a partial function as an electronic catalog, electronic personal history (resume), or electronic stock certificate. The market of trading with the providers of resources for information processing services can be utilized as a point of contact with social economic activity.

The present invention may be embodied in other specific forms without departing from the spirit or essential characteristics thereof. The described embodiment is to be considered in all respects only as illustrated and not restrictive. The scope of the invention is, therefore, indicated by the appended claims rather than by the foregoing description. All changes which come within the meaning and range of equivalency of the claims are to be embraced within the scope of the claims.

What is claimed is:

1. A method for providing information services comprising a means for controlling brokering and booking resources for offering a service (the means will be referred to as a brokering means hereinafter) intervening between resources for information processing services to be offered by a plurality of providers of the resources for information processing services and administrators of operating information service systems including computer platforms (both the providers and administrators will be referred to as service resource providers hereinafter) and users of said resources, said brokering means holding credit data including resource performance data for the resource providers, said brokering means comprising the steps of:
receiving performance request specifications of resources for a user-desired service from the user;
simulating estimated service performance of resources, based on said request specifications and said credit data, thereby allocating one or more combinations of serviceable resources that satisfy, in the aggregate, said request specifications;
issuing a resource reservation ticket to the user, the ticket including data that entitles the user to utilize said one or more combinations of resources; and
placing an order with the resource providers for said one or more combinations of resources, thereby booking the resources for the user.

2. The method for providing information services as recited in claim 1, wherein said brokering means executes simulation of the performance of resources, based on the user's request specifications, allocates the adequately-performing resources of one or more resource providers, according to the result of the simulation, determines what quantity of resources are necessary and sufficient for fulfilling said request specifications and time during which function and resources are required to run, and issues the resource reservation ticket, according to the allocation, wherein the brokering means will issue the respective resource reservation tickets to a plurality of service users (customers), moreover, after successfully reserving the resources, the brokering means sends the service performance request specifications, based on which the resources have been reserved, to the providers of the allocated resources, and when the resource providers determine their service resources required to execute the service in future, the brokering means compares available function and resources and required function and resources for a specific period and manages the thus obtained data to decide whether the service providers can provide additional service performance resources.

3. The method for providing information services as recited in claim 1, wherein data to be written to the resource reservation ticket to be traded includes a requested service type and service performance data in which maximum time and average time estimated to be taken to execute the information processing service are specified and the brokering means performs at least either estimating whether the resources can execute the information processing service described in the performance request specifications or estimating how well the resources satisfy the performance request specifications.

4. The method for providing information services as recited in claim 1, further including a means for re-estimating the performance of resources for an additional order, said means to re-calculate resource performance specification parameters necessary and sufficient for executing the information processing service specified in the user's performance request specifications and present the data of the calculated performance specification parameters to the resource providers if said brokering means estimates that the resources cannot execute the information processing service specified in the performance request specifications within the maximum time.

5. The method for providing information services as recited in claim 1, wherein the reliability of the service providers is evaluated by comparing the guaranteed service performance of the reserved resources and the service performance during or after the actual run of the resources and the evaluation output data is recorded as part of the credit data.

6. The method for providing information services as recited in claim 1, wherein, if one or more allocated resources on computer platforms become unable to operate when executing the service, switching from the resources of relatively low reliability service performance to other resources of relatively high reliability service performance is performed by dynamically gaining access to the credit data, thereby providing run-time endorsement of the resource reservation ticket.

7. The method for providing information services as recited in claim 1, wherein said brokering means determines whether the resources can provide the service from the performance data of the resource providers' computer platforms required to execute the service, while taking the providers' credit evaluation into consideration by referring to the credit management data.

8. The method for providing information services as recited in claim 1, wherein said brokering means edits the performance request specifications data for an information processing service electronically sent from the user of the information processing service into resource reservation data for assigning the resource run tasks to the resource providers, according to the information processing service type, electronically sends said resource reservation data to the appropriate resource providers, issues the resource reservation ticket created with the input of said resource reservation data, and stores the resource reservation data into a storage medium for management.

9. A method for reserving and managing information service resources comprising brokering systems in multilevel hierarchical structure, each brokering system including a resource management table, means for registration, and a storage medium, arranged such that lower-level brokering systems gain access to an upper-level brokering system as a user of the brokering system, wherein the resource management table of the upper-level brokering system contains partial data, a copy of the relevant part of Service Level Management data, resource reservation data, credit management data for service resource providers which are maintained in the lower-level brokering systems, a top level brokering system includes a brokering means that executes the method recited in at least one of claims 1 to 8 and group-bounded service request specifications data, and users service request specifications input to the lower-level brokering systems are collected as said group-bounded service request specifications data on the top-level brokering system.

10. An apparatus for authenticating an authorized service user comprising a means for authorized service user authentication which authenticates that the user is authorized to use service by verifying the validity of the user's resource reservation ticket issued to guarantee the right of the service user and the performance of the resources to execute the service, a first storage means to store said resource reservation ticket data, a second storage means to store resource allocation information, a means for communication between said first storage means and second storage means, and a means for verifying certificate data which executes predetermined arithmetic processing based on algorithm for encryption/decryption and other security purposes for the reservation data and resource allocation data and verifies the validity of the resource reservation.
